(19) United States
(12) Patent Application Publication
(10) Pub. No.: US 2007/0255546 A1
(43) Pub. Date: Nov. 1, 2007

(54) Simulation System and Computer-Implemented Method for Simulation and Verifying a Control System

(76) Inventor: Karsten Strehl, Stuttgart (DE)

Correspondence Address: KENYON & KENYON LLP, ONE BROADWAY, NEW YORK, NY, 10004, US

(21) Appl. No.: 10/578,971

(22) PCT Filed: Nov. 10, 2004
(86) PCT No.: PCT/EP04/12735

§ 371 Date: Mar. 8, 2007

(30) Foreign Application Priority Data
Nov. 10, 2003 (EP) 03025834.7

(51) Int. Cl. G06F 17/50

(52) U.S. Cl. 703/13

(57) ABSTRACT

A simulation system and method are for computer-implemented simulation and verification of a control system under development, the simulation system including a generic model animation and in-model calibration interface, which uses measurement and calibration technologies with a host-target architecture, whereby the host includes at least one respective modeling tool and on the target software of the control system is executed.

### FIELD OF THE INVENTION

The present invention relates to a simulation system for computer-implemented simulation and verification of a control system under development as well as a computer-implemented method for simulating and verifying a control system under development. More particularly, the present invention relates to the so-called rapid prototyping of a control system for dynamic systems such as vehicles, aircrafts, ships, etc. as well as parts thereof. Further, the present invention relates to a computer program product with a computer-readable medium and a computer program stored on the computer-readable medium with program coding means which are suitable for carrying out such a process when the computer program is run on a computer.

### BACKGROUND INFORMATION

Rapid prototyping of control systems is commonly used in the automotive industry, aviation, etc. for early verification of the correct, functional and real-time behavior of a control system under development. Like this, control strategies and algorithms for dynamic systems such as vehicles or parts thereof can be tested under real-world conditions without requiring the existence of the final implementation of the control loop.

A rapid prototyping system usually is characterized as being a hybrid hardware/software system, in general consisting of the following main components:
a simulation target, consisting of one or several simulation processors with corresponding memory modules, each running basically a portion of a model of the control system under development,
input interfaces composed of signals being fed by the plant (the outside world being controlled),
output interfaces composed of signals feeding the plant, and
communication interfaces for downloading the module from a host (often a personal computer) onto the simulation target, controlling the simulation experiment (start and stop commands, etc.), measuring and calibrating module signals and parameters, respectively.

FIG. 1 illustrates a conventional simulation system 10 at the model level. Technically the simulation system 10 includes one or more simulation processors with corresponding memory modules on which portions 12a, 12b, 12c of a model of the control system under development (or so-called sub-models) are run. The simulation system 10 further includes an input interface 13a and an output interface 13b for exchanging signals with the so-called outside world. Finally, the simulation system includes a communication interface for downloading the module from a host onto the simulation target, controlling the simulation experiment, measuring and calibrating module signals and parameters, respectively. FIG. 1 is at the model level, not at the technical level. With 14 are stimuli signals named, used where no physical input signals are available. Separate from this is the communication interface later described with regard to FIG. 3. The communication interface hereof could be added into the FIG. 1 structure if desired.

Signals of the input and output interfaces can be analog (e.g., temperature or pressure sensor) or digital (e.g., communication protocol such as CAN). Within simulation experiments, the rapid prototyping system is used as integral part of the control loop, just the way finally the controller (electronic control unit) will be.

The preparation of a rapid prototyping experiment in general consists of the following steps:

1. creation of a mathematical model of the control system, for instance, by means of a behavioral modeling tool (such as MATLAB®/Simulink®¹ or ASCET-SD²) or by hand,
¹ INCA, L1 and Distab protocol are communication protocols proprietary to ETAS GmbH (a Robert Bosch GmbH subsidiary).

² The ASAPlb communication protocol has been standardized by the ASAM association.

2. manual transformation (hand coding) or automated transformation (code generation) of the model into program code in some high-level programming language (C, for instance),

3. compilation and linkage of the program code into an executable,

4. download of the executable from the host onto the simulation target via the host-target communication interface, and

5. setup and invocation of the experiment from the host via the communication interface.

Frequently, several model parts (called modules in the following) from one or several sources (e.g., behavioral modeling tool, hand-written C code) are to be integrated with each other, so as to compose an entire control system's model. The communication among modules 12a, 12b, 12c as well as between modules and input or output interfaces 13a, 13b (likewise considered as modules in the following) is performed via signals connecting input and output ports, depicted as circles in FIG. 1.

Conventionally, this communication is achieved by sharing the very same memory location (the same high-level language variable) for ports being connected with each other, where one module writes the current value of the signal into the given memory location and the other module reads from it.

In order to achieve this, the transformation of the model into executable code needs to be performed in a manner depending on the actual interconnection scheme, denoting that output port a of module A be connected with input port b of module B, for instance. In this example, both ports a and b would need to be statically mapped onto the very same memory location on the simulation target so as to enable inter-module communication.

With this conventional static interconnection approach, signals connect ports with each other in an inseparable manner. Whenever one or several connections between signals are to be established, modified or cut off, the entire process of model-to-code transformation, compilation and linkage, executable download, experiment setup and invocation needs to be performed. For real-world models, this process is very time consuming and may take up to several tens of minutes or even more. Especially when correcting a faulty connection being made inadvertently, current turn-around times are far too large. Further, as soon as the experiment has been downloaded and started, connections cannot be altered, added, or removed any longer.

As said before rapid prototyping of control systems is commonly used in the automotive industry, aviation, etc., for early verification of the correct functional and real-time behavior of a control system under development. Like this, control strategies and algorithms for dynamic systems such as vehicles or parts of them can be tested under real-world conditions without requiring the existence of the final. implementation of the control loop.

Following rapid prototyping, the control system's final software is being developed. The result is a production quality software executable for the electronic control unit being targeted. Particularly, this phase involves coding the software, testing and observing it under real-world conditions, and calibrating its parameters, so as to tune the behavior according to given requirements. The basis for the latter two steps are measurement and calibration (M & C) technologies.

M & C technologies could be used with a host/target architecture where
the host in general is the PC running the M & C tool,
the target mostly is an embedded computer running the controller, e.g.,
   dedicated experiment hardware for rapid prototyping or
   an electronic control unit (ECU) for software development, and
host and target are connected with each other via dedicated M & C communication interfaces.

Of both host and target, several instances may be involved in a distributed M & C system.

The M & C tool usually performs tasks such as
measuring the values of variables in the control system's software, displaying them in form of graphical instruments such as scopes, dials, gauges, or numerical displays, and logging them onto disk, and
calibrating the values of parameters, e.g., scalars, arrays, or interpolated maps, by displaying them in form of graphical input devices such as sliders, buttons, knobs, curves and 3D maps, or numerical displays, and sending any alterations of the current value made by the user down to the control system's software.

M & C tools rely on a number of standardized M & C interfaces being either true or de-facto standards, especially in the automotive industry. The availability of those interfaces can be assumed in automotive hardware for both rapid prototyping or software development, especially for A-step and B-step ECUs. In this context, experiment environments as used for rapid prototyping are considered M & C tools as well, though of restricted or partly different functionality.

M & C interfaces need to be supported by both software and hardware, on the host as well as on the target. Roth are connected with each other via some physical interconnection running some communication protocol. The M & C tool on the host in general uses software drivers for this purpose, while the target hardware runs dedicated protocol handlers. Examples for M & C protocols are COP, XCP, KWP2000, or the INCA¹, ASAPlb²/L1¹, and Distab¹ protocols. Physical interconnections are, e.g., CAN, ETK³, Ethernet, FlexRay, USB, K-Line, WLAN (IEEE 802.11), or Bluetooth. For the development of embedded control systems, often behavioral modeling tools are employed, such as ASCET⁴, MATLAB®/Simulink®⁵, Statemate MAGNUM™⁶, and UML or SDL tools. These tools in general provide some graphical user interface for describing a control system's structure and behavior by block diagrams, state machines, message sequence charts, flow diagrams, etc. Like this, a mathematical model of the control system may be created. Once the model is available, an automated transformation (code generation) of the model into program code in some high-level programming language (C, for instance) and finally in an executable program can be performed, either for rapid prototyping or as the production quality ECU software.
³ The ETK is an ETAS proprietary physical interconnection.

⁴ ASCET is a product family by ETAS GmbH.

⁵ MATLAB®, Simulink®, and Real-Time Workshop® are registered trademarks of The Mathworks, Inc.

⁶ Stalemate MAGNUM™ is a registered trademark of I-Logix, Inc.

As a convenient way of testing and debugging a control system's software or the model itself, many modeling tools provide device(s) for animating the model during its simulation or execution by visualizing its behavior, e.g., by
displaying current signal values on top of signal lines,
displaying them in a graphical instrument, or
highlighting active and previously active state machine states directly within the modeling environment.

Like this, no separate experiment environment is needed. Further, some tools provide the possibility of directly calibrating parameter values via the modeling environment, using the normal user interface of the modeling tool.

This conventional approach of model animation and in-model calibration is available on experiment hardware only, for instance, on a PC running both the modeling tool and the experiment at the same time (off-line simulation) or together with dedicated rapid prototyping hardware (on-line simulation). Further, proprietary communication protocols are used, e.g., the external mode protocol of MATLAB®/Simulink® or the L1 protocol in ASCET.

This conventional approach as described above is shown in FIG. 6.

The conventional approach is known to be employed by rapid prototyping systems such as those of ETAS GmbH (ASCET-SD product family), The Mathworks, Inc. (MATLAB®/Simulink®, Real-Time Workshop®, xPC Target) and presumably others.

Such a static interconnection as conventional is visualized in FIG. 2a. FIG. 2a shows a first module 12d and a second module 12e which are sharing a variable which is stored in a static memory location 81.

### SUMMARY

Example embodiments of the present invention may provide more flexible interconnection of hitherto static connections so that a simulation already being performed may be easily corrected, intercepted or modified. Example embodiments of the present invention may improve communication between single components of a simulation systems as well as communication between single modules of a simulation model for providing a rapid prototyping of a control system of a vehicle.

In contrast to conventional approaches as described above, the dynamic interconnection approach hereof may not rely on interconnection scheme specific model-to-code transformation. Instead, this transformation is totally independent of the actual module interconnections being used. Rather, inter-module communication is performed in an explicit manner by using distinct memory locations instead of shared ones and copying or replicating signal values from one memory location to another when needed.

Therefore a simulation system for computer-implemented simulation and verification of a control system under development is provided, wherein the simulation system including a generic model animation and in-model calibration interface, which uses measurement and calibration technologies with a host-target architecture, wherein the host contains at least one respective modeling tool and on the target software of the control system is executed. A computer-implemented method is for simulating and verifying a control system under development by such a simulation system and a computer program with program coding devices which are suitable for carrying out this method, when the computer program is run on a computer and also a computer program product with a computer-readable medium like a RAM, DVD, CD-ROM, ROM, EPROM, EPROM, EEPROM, Flash, etc. and a respective computer program stored on the computer-readable medium.

A target server may be used to connect the modeling tool with the target and the target server contains a protocol driver of a communication protocol used for communication with the target.

A simulation system may include a plurality of simulation processes with corresponding memory and interface modules, which modules include distinct memory locations for inter-module communication and wherein simulation is performed by running a control system simulation model, the simulation model including a number of sub-models being performed on one of the plurality of modules, respectively, wherein at least some of the modules are dynamically reconfigurable for communication via distinct memory locations.

A host of a simulation system is for computer-implemented simulation and verification of a control system under development, the host including a generic model animation and in-model calibration interface, which uses measurement and calibration technologies for a host-target architecture, whereby the host includes at least one respective modeling tool and a target server to connect the modeling tool with the target.

Since the interconnection scheme is not reflected by the mere simulation executable, it needs to be passed on to the simulation target differently. This is achieved by dynamically setting up the actual module interconnections via the host-target communication interface during experiment setup, after having downloaded the executable.

The exchange of signal values will be performed according to the respective interconnection scheme. No implicit naming conventions as with the static memory sharing approach are required. Rather, the current value of a given signal is distributed from an output port to any connected input port by explicitly reading the value from the memory location associated with the output port and then replicating it to any memory location corresponding to a relevant input port.

Certain major aspects (which will be described in more detail in the description) of this approach are:
The availability of required interfaces in form of M & C technology in the relevant hardware and software may be assumed since the approach is based on standardized solutions.
There is no need for porting any software onto each combination of target hardware and physical interconnection, which otherwise constitutes tremendous efforts.
The same modeling tool interface may be used for model animation and in-model calibration during off-line and on-line experiments as well as during ECU operation.
There is neither memory nor run-time overhead on the target hardware since no additional proprietary protocol handler is needed.
There is no bandwidth overhead on the physical interconnection since no additional proprietary protocol is run.
The run-time behavior of the model on the target hardware is unaffected since no background tasks or similar are needed for communication.
Hence, especially ECUs (in general providing very low memory as well as run-time resources and intrinsically supporting M & C technologies on large numbers of hardware and interface variants) are ideally supported.
A log & replay off-line debugging functionality is supported.
The turn-around times after altering the interconnection scheme are reduced significantly since the time consuming process of model-to-code transformation, compilation and linkage, and executable download needs not he repeated. This strongly supports the actual application of rapid prototyping.
Signals connecting ports may be established, modified, or removed even during a running experiment without perceptible delay. This enables completely new possibilities of use such as the following:
   correcting faulty connections on the fly, even without interrupting the experiment,
   gradually setting up an experiment by putting portions of the entire model into operation little by little while continually establishing the final interconnection scheme,
   spontaneously stimulating the model by establishing connections to its input ports,
   switching an input port from a predefined stimulus module over to a real-world input signal,
   comparing a number of implementation variants of the same module running in parallel by alternatively switching their outputs to the plant, or
   swapping inputs or outputs to the rapid prototyping system virtually on the tool level, instead of first pulling out and again plugging in physical cable connections.

Therefore, a simulation model is run to simulate and verify a control system during development, the simulation model includes a number of sub-models which are run on the same or different nodes (processors) of a simulation system. Communication between the respective modules of the simulation model as well as the simulation system is performed via distinct and separate memory locations, the modules being dynamically connected with each other.

The data and/or signals may be replicated consistently by a cross-bar switch. For example, this replication is performed under real time conditions.

The modules may interconnect automatically via interconnection nodes and replicate data.

A consistent replication of data under real-time circumstances or conditions may be done via communication variables. The cross-bar switch as mentioned above provides for consistently copying values of output signals to communication variables after reaching a consistent state. Further, the cross-bar switch provides for consistently passing these values to connected input signals before the respective modules continue computation. Depending on the respective real time architecture of the simulation system and/or the set-up of the real-time operating system a consistent copy mechanism may be achieved by atomic copy processes, blocking interrupts, etc. Under certain circumstances being determined by the respective real-time environment settings, signal variables or communication variables may be obsolete and then may be optimized away for higher performance.

A distributed approach may be used for dynamic reconfiguration of module interconnections instead of the central approach as described above. In this alternative arrangement, ports may connect themselves to their respective counterparts and be responsible for signal value replication.

A computer program with program coding devices may be suitable for carrying out a process as described above when the computer program is run on a computer. The computer program itself as well as stored on a computer-readable medium is described.

Further features and aspects of example embodiments of the present invention are described below with reference to the appended Figures.

It should be understood that the features mentioned above and those described hereinafter may be used not only in the combination specified but also in other combinations or on their own, without departing from the spirit and scope hereof.

### BRIEF DESCRIPTION OF THE DRAWINGS

FIG. 1 is a schematic block illustration of a simulation system at the model level.

FIG. 2a is a schematic illustration of a conventional static interconnection of the prior art.

FIG. 2b illustrates an example embodiment of a dynamic interconnection according to the present invention.

FIG. 3 illustrates an example embodiment of a simulation system according to the present invention using a dynamic interconnection according to FIG. 2b.

FIG. 4 illustrates an example of a consistent replication under real-time circumstances via communication variables according to an example embodiment of the present invention.

FIG. 5 illustrates an example embodiment of an interconnection scheme according to the present invention.

FIG. 6 illustrates architecture of model animation and in-model calibration.

FIG. 7 illustrates an example for a model animation and in-model calibration approach with a target server.

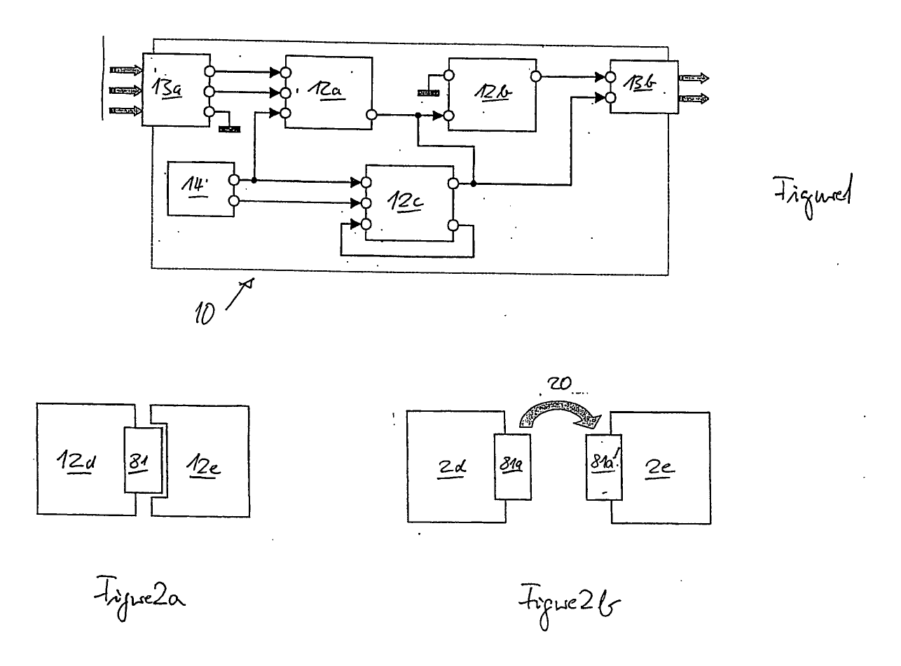

### DETAILED DESCRIPTION

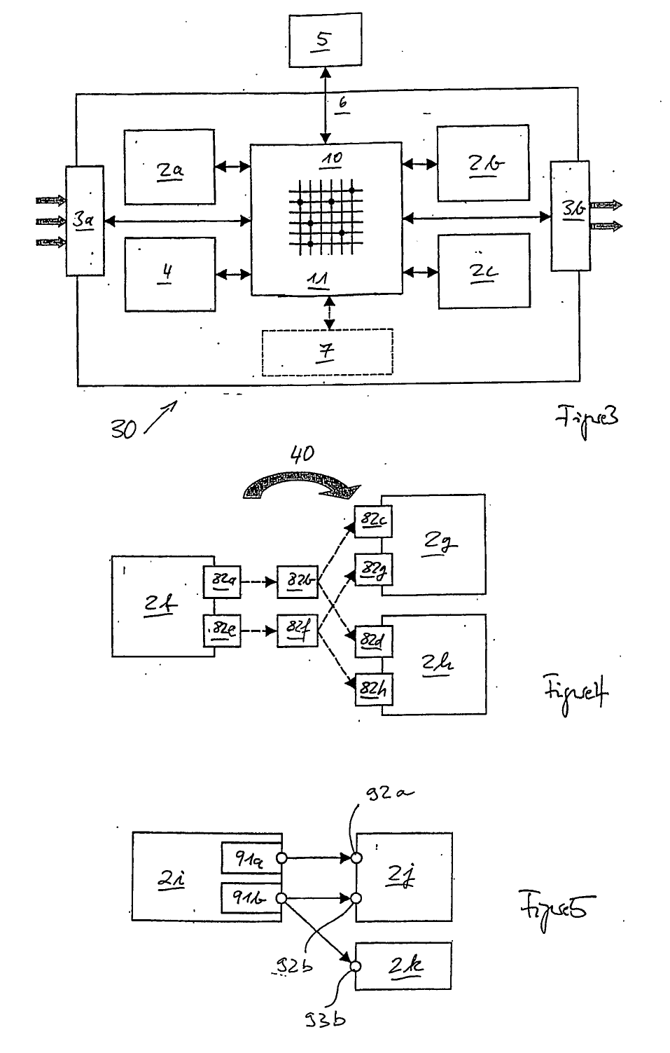

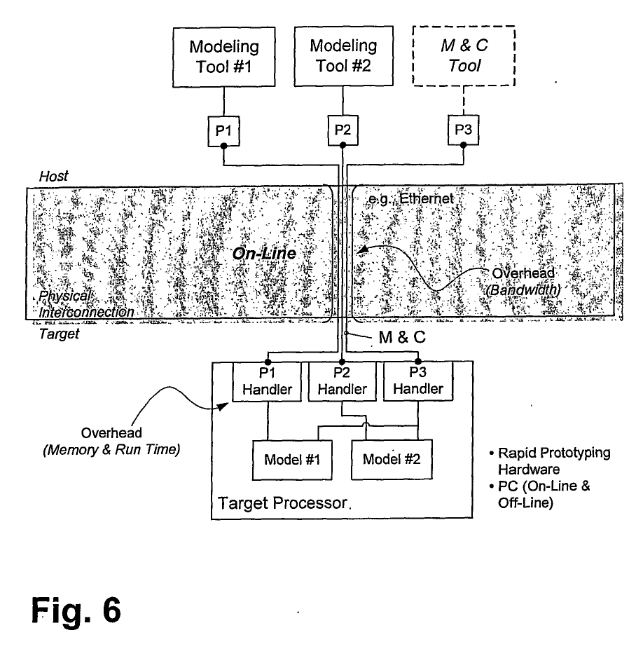

According to example embodiments of the present invention and in contrast to conventional static connection as described above with reference to FIG. 2a, a dynamic interconnection approach via distinct memory locations is provided. The principles of the dynamic interconnection is visualized in FIG. 2b wherein data 81a of a first module 2d are copied or replicated by dynamic replication 20 in a distinct memory location of a second module 2e as according data 81a′.

Several architectures underlying the dynamic reconfiguration approach may be provided. With reference to FIG. 3, an example for a simulation system 30 is described in the following as the so-called central approach.

The main component of the central approach simulation system 30 is a so-called cross-bar switch 10 with an interconnection scheme 11. The simulation system 30 further includes a plurality of modules 2a, 2b, 2c, an input interface 3a, an output interface 3b, a stimuli generator module 4 as well as a real-time operating system 7.

As visualized by the double headed arrows in FIG. 3, all components of simulation system 30 are interconnected with each other via the cross-bar switch, the interconnection scheme 11 defining which input and output ports of modules on the simulation target are connected with each other. The interconnection scheme corresponds to the totality of connections in a block diagram wherein each block corresponds to one of the modules being integrated on the simulation target 30.

The interconnection scheme 11 may be provided as a two-dimensional switch matrix wherein both dimensions denote the modules' ports and the matrix values define whether the respective ports are connected with each other (and possibly the signal flow direction).

A simulation host 5 is connected with the cross-bar switch 10 via a host-target communication interface 6 and constitutes the human-machine interface to the rapid prototyping system.

The host 5 provides the configuration and reconfiguration of the interconnection scheme, e.g., supported by some graphical user interface.

The host-target communication interface 6 connects the simulation host 5 with the simulation target 30. In general, it is based on some wired or wireless connection (serial interface, Ethernet, Bluetooth, etc.) and standardized or proprietary communication protocols (e.g., ASAPlb, L1). It provides at least the following functionality:
download of the simulation executable from the host 5 to the simulation target 30 and
download of configuration data defining the interconnection scheme 11.

Further, it may provide functionality for
controlling the experiment, e.g. for starting and stopping the simulation,
measuring values of model signals, interconnection signals, and input or output signals,
calibrating model parameters, etc.

The cross-bar switch 10 runs on the simulation target and is connected with
the simulation host 5 via the host-target communication interface 6,
modules 2a, 2b, 2c representing model portions or sub-models of the control system under development,
modules 3a, 3b representing input and output interfaces to the control system's plant,
modules 4 serving as stimuli generators to the model, and
e.g., a real-time operating system 7 underlying the simulation experiment.

Before starting a simulation experiment, the initial interconnection scheme 11 is downloaded from the host 5 via the host-target communication interface 6 into the cross-bar switch 10.

During a running experiment, the cross-bar switch 10 performs the actual communication among modules and components by copying signal values from output ports to input ports. The manner in this replication process is performed is defined by the interconnection scheme 11.

The interconnection scheme 11 may be reconfigured after interrupting or even during a running simulation. Thus, module interconnections may be altered on the fly, without perceptible delay.

Referring now to FIG. 4, an alternative of a transmission of signals and/or data is illustrated. By dynamic replication 40, signal and/or data values 82a, 82e of a first module 2f may be buffered as communication variables 82b, 82f, respectively, in distinct memory locations. By further dynamic replication 40, second and third modules 2g, 2h receive respective signal and/or data values 82c, 82g and 82d, 82h, respectively.

Thus, data consistency within a real-time environment is provided. Each module 2t, 7g, 2h may compute at, e.g., a different rate or upon interrupt triggers, and data replication 40 is performed by communication variables 82b, 82f buffering the current signal values. Thus, the values of several output signals which as a whole constitute a valid state are guaranteed to be copied in a consistent manner such that modules being fed by these output signals may themselves rely on a valid state.

As already mentioned above, the cross-bar switch 10 provides for
consistently copying values of output signals to communication variables after reaching a consistent state and
consistently passing these values to connected input signals before the respective modules continue computation.

The consistent copy mechanism as described may be achieved by atomic copy processes, blocking interrupts, etc., depending on the underlying real-time architecture and operating system.

Under certain circumstances being determined by the respective real-time environment settings, signal variables or communication variables may be obsolete and then may be optimized away for higher performance.

The above-described dynamic reconfiguration approach may be extended by signal conditioning facilities. In order to achieve this, each signal value may be influenced during inter-module communication in a pre-defined manner after reading the original value from the source memory location and before writing to the target memory location.

Possible signal conditioning operations are:
implementation formula adaptation (e.g., scale or offset modification, saturation) or
basic mathematical operations (e.g., sum, difference, multiplication of signals, mapping via look-up table or characteristic with interpolation, constant value).

The kind of operation being applied and the respective parameters are considered as being part of the interconnection scheme. Each of them may be configured and reconfigured in a dynamic manner, as may module interconnections. This enhancement may greatly widen the usefulness of the dynamic reconfiguration approach.

Referring now to FIG. 5, a distributed approach for dynamic reconfiguration of module interconnections which may be used instead of the central approach employing a distinct cross-bar switch component on the target is described. Rather than having a central component copy signal values, ports could “connect themselves” to their respective counterparts and be responsible for signal value replication.

For instance, this may be achieved by having input ports 92a, 92b and 93b of modules 2j and 2k register themselves at output port servers 91a, 91b of module 21 upon connection, each of which represents a given output port. Communication may be performed either following a pull approach (input port queries signal value) or a push approach (multi-cast of signal value, invoked by output port). Thus, the intelligence for value replication is distributed over the system's components instead of concentrating it in a central cross-bar switch component.

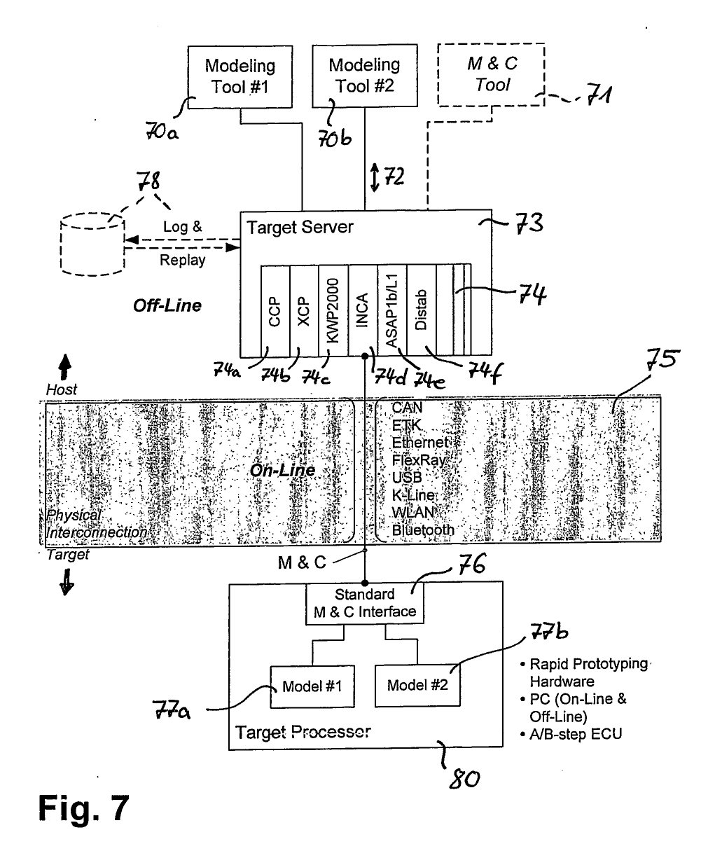

Generic Model Animation and In-Model Calibration Interface for Rapid Prototyping and Software Development (FIG. 7)

A generic model animation and in-model calibration interface for rapid prototyping and software development, which uses measurement and calibration technologies with a host-target architecture and a respective simulation system and method.

The Basic Concepts

In contrast with the described approach in the state of the art, the generic model animation and in-model calibration approach being the subject of this invention does not rely on either dedicated simulation or rapid prototyping hardware or proprietary communication protocols. Instead, standard M & C technology is used.

As described before certain major aspects of this approach are:
The availability of required interfaces in form of M & C technology in the relevant hardware and software may be assumed since the approach is based on standardized solutions.
There is no need for porting any software onto each combination of target hardware and physical interconnection, which otherwise se constitutes tremendous efforts.
The same modeling tool interface may be used for model animation and in-model calibration during off-line and on-line experiments as well as daring ECU operation.
There is neither memory nor run-time overhead on the target hardware since no additional proprietary protocol handler is needed.
There is no bandwidth overhead on the physical interconnection since no additional proprietary protocol is run.
The run-time behavior of the model on the target hardware is unaffected since no background tasks or similar are needed for communication.
Hence, especially ECUs (in general providing very low memory as well as run-time resources and intrinsically supporting M & C technologies on large numbers of hardware and interface variants) are ideally supported.
A log & replay off-line debugging functionality is supported.
For generic model animation, these standard interfaces are used for animating the control system's software, or a model thereof, or visualizing its behavior.
For in-model calibration, these standard interfaces are used for calibrating parameters of the control system's software from within its model.
For log & replay, these standard interfaces are used for logging measured data onto the host for transparently replaying it later on to the modeling tool for animation and visualization.
Using the standard interfaces is possible on most relevant hardware systems (combination of target, host, and interconnection in between), hence, no additional efforts for software adaptation or porting is needed.
For simulation on the host or rapid prototyping targets as well as for ECU operation, the same standard interfaces may be used.
Memory, run-time, and bandwidth overheads are avoided due to the use of available standard interfaces.

Off-line debugging devices, for instance, that during an on-line experiment, first the measured data is logged onto the host's memory or hard disk. Afterwards, the data is replayed in off-line mode to the modeling tool, imitating the previously connected rapid prototyping hardware or a running ECU. This may be performed completely transparent to the modeling tool. Further common debug features provided by this approach are single-step execution and model breakpoints, support by the modeling tool assumed.

In FIG. 7 the Modeling Tools 70a and 70b and optional the M&C Tool 71 are illustrated. Between these Modeling Tools 70a and 70b and optional 71 a and the target 80 a model animation interface 72 is situated. A target server 73 with protocol drivers 74 (e.g. CCP 74a, XCP 74b, KWP2000 74c, INCA 74d, ASAP 74e, Distab 74f, usw.) or similar is connected to the physical interconnection 75. The standard M&C interface 76 in the Target 80 connects this physical interconnection 75 to the Models 77a and 77b. On the target or the target processor as at least a part of the control system under development the application SW is executed. This architecture is one example for an inventive simulation system. Several architectures underlying the generic model animation and in-model calibration approach may be provided. As an example, this Target Server based approach is described in the following. Its main component is the Target Server running on the host computer and building the bridge between the modeling tools on the host and the target hardware.

Alternatively Lo a single target connected with one physical interconnection, several different hardware targets connected via diverse communication channels are possible, constituting a distributed system. Further, each modeling tool may be used for animation and calibration of any number of models on the target at a time.

The Function

The Target Server

The Target Server is the central component of the generic model animation and in-model calibration approach. Its role is that of target hardware and communications abstraction. The main task of the Target Server is to connect the modeling tools with the target hardware's M & C interface in a transparent manner.

Like this, the modeling tools need not be aware of the respective hardware used as target or of the communication protocols or physical interconnections being used as host/target interface. For this purpose, the Target Server may include a dedicated protocol driver or similar for each supported communication protocol, in order to perform the translation from model animation related communication into M & C specific protocols.

Another task of the Target Server is to log measured data onto the host's memory or hard disk, in order to use it for off-line debugging replay later on.

The Modeling Tools

The modeling tools access the Target Server via its model animation interface. Like this, data needed for animating the model is passed from the target to the modeling tool. Further, calibration data is passed in the other direction from the modeling tool down to the target hardware. Basic model animation and in-model calibration are available in the modeling tool as soon as it uses the Target Server for target access instead of proprietary communication protocols. For advanced log & replay features such as single-step debugging and model breakpoints, the modeling tool is assumed to provide additional functionality.

The M & C Tool

An M & C tool may run in parallel to the modeling tools, using the very same M & C interfaces and communication channels. However, this is no prerequisite for generic model animation and in-model calibration but depicted for demonstrating the conventional M & C approach.

In case multiple (modeling or M & C) tools simultaneously attempt to calibrate one and the same set of parameters, an arbitrage scheme must he used for safety and data consistency. This arbitrage scheme may employ one or more of the following techniques, for instance:
locking of all but one tool for calibration of the given parameter net (master/slave principle), e.g., by using read only parameters,
notification of all other tools after calibrating parameters of the given set, or
parameter refresh by all affected tools via periodic measurement of the given parameter set (polling).

The Application Software

The application software running on the target mainly consists of the models' code, a real-time operating system or a scheduler invoking the model code, hardware and communication drivers enabling model input and output, etc. The code generated from the models being simulated performs computations according to the models' specified behavior. The data structures in the code are accessed (read and write) by the standard M & C interface in order to perform conventional measurement and calibration or model animation and in-model calibration, respectively.

The Standard M & C Interface

The standard M & C interface on the target constitutes the link between application software and the Target Server. It accesses model data for measurement and calibration and is connected via the physical interconnection with the host.
For measurement, the M & C interface reads data from the application software and passes it via the M & C protocol to the Target Server which routes it to the modeling tools and the M & C tool (if applicable).
For calibration, a modeling tool or the M & C tool sends new parameter values via Target Server and M & C protocol to the M & C interface which updates them in the application software on the target.

As standard M & C interface, for instance, the CCP, XCP, KWP2000, INCA, or ASAPlb protocols may be used, based on, e.g., CAN, Ethernet, FlexRay, USE, or K-Line as physical interconnection.

Alternatives

Decentralized Approach

Instead of using a central Target Server component, each modeling and M & C tool could incorporate the host-side M & C interface adaptation on its own. Like this, the abstraction from target hardware may still maintained, while the abstraction from communication channels may be transferred to the tools involved.

For this reason, target access may be less transparent, and the number of M & C interfaces being supported may be smaller. Further, the support of log & replay off-line debugging may be more expensive. On the other hand, not all modeling and M & C tools may need to comply with one and the same interface of a Target Server component as otherwise.

M & C Tool Interface Approach

Instead of having modeling tools directly access the Target Server, an M & C tool may be used as intermediary. For this, the model animation interface may not be incorporated in the Target Server but in the M & C tool, e.g., an experiment environment for rapid prototyping. The modeling tools may then connect to this interface. This approach may more easily provide support for calibration arbitrage since
in general only the M & C tool and a single modeling tool compete in calibrating the same sets of parameters, and
the M & C tool may receive calibration commands from the modeling tool, interpret them for its own purposes (refresh of displayed value, data storage, etc.), and pass them to the Target Server for the actual calibration process.

1-10. (canceled)

11. A simulation system for computer-implemented simulation and verification of a control system under development, comprising:
a generic model animation and in-model calibration interface adapted to use measurement and calibration technologies with a host-target architecture, a host including at least one respective modeling tool and on target software of the control system is executed.

12. The system according to claim 1, further comprising a target server adapted to connect the modeling tool with a target.

13. The system according to claim 2, wherein the target server includes a protocol driver of a communication protocol adapted for communication with the target.

14. The system according to claim 1, further comprising a plurality of simulation processes with corresponding memory and interface modules, the modules including distinct memory locations adapted for inter-module communication.

15. The system according to claim 4, wherein simulation is performed by execution of a control system simulation model, the simulation model including a plurality of sub-models being performed on one of the plurality of modules respectively.

16. The system according to claim 4, wherein at least some of the modules are dynamically reconfigurable for communication via distinct memory locations.

17. A host of a simulation system for computer-implemented simulation and verification of a control system under development, comprising:
a generic model animation and in-model calibration interface adapted to use measurement and calibration technologies for a host-target architecture, the host including at least one respective modeling tool and a target server to connect the modeling tool with a target.

18. A method, comprising:
computer-implemented simulating and verifying a control system under development by of a simulation system including a generic model animation and in-model calibration interface adapted to use measurement and calibration technologies with a host-target architecture, a host including at least one respective modeling tool and on target software of the control system is executed.

19. A computer-readable storage medium including a set of instructions executable by a computer, the set of instructions comprising:
computer-implemented simulating and verifying a control system under development by of a simulation system including a generic model animation and in-model calibration interface adapted to use measurement and calibration technologies with a host-target architecture, a host including at least one respective modeling tool and on target software of the control system is executed.
